(19) United States
(12) Patent Application Publication
(10) Pub. No.: US 2026/0204825 A1
(43) Pub. Date: Jul. 16, 2026

(54) HIGH POWER CONNECTOR

(71) Applicant: Tyco Electronics AMP Korea Co., Ltd., Gyeongsan (KR)

(72) Inventor: Byung-Hee Cho, Gyeongsan-Si (KR)

(73) Assignee: Tyco Electronics AMP Korea Co., Ltd., Gyeongsan (KR)

(21) Appl. No.: 19/449,555

(22) Filed: Jan. 15, 2026

(30) Foreign Application Priority Data
Jan. 15, 2025 (KR) 30-2025-0001874
Jan. 15, 2025 (KR) 30-2025-0001875
Jan. 24, 2025 (KR) 10-2025-0011535
Jan. 9, 2026 (KR) 10-2026-0004470

(51) Int. Cl. H01R 13/24; H01R 12/70; H01R 12/71

(52) U.S. Cl. CPC H01R 13/2492; H01R 12/707; H01R 12/714

(57) ABSTRACT

A high-power connector includes a receptacle assembly and a tab assembly. The receptacle assembly includes a plurality of receptacle-side power terminals for forming multiple contacts, and a plurality of receptacle-side signal terminals. The plurality of receptacle-side power terminals are disposed in parallel. The tab assembly includes a plurality of tab-side power terminals corresponding to the plurality of receptacle-side power terminals, and a plurality of tab-side signal terminals corresponding to the plurality of receptacle-side signal terminals.

### CROSS-REFERENCE TO RELATED APPLICATIONS

This application claims the benefit of the filing date under 35 U.S.C. § 119(a)-(d) of Korean Patent Application No. 30-2025-0001874, filed on Jan. 15, 2025, Korean Patent Application No. 30-2025-0001875, filed on Jan. 15, 2025, Korean Patent Application No. 10-2025-0011535, filed on Jan. 24, 2025, and Korean Patent Application No. 10-2026-0004470, filed on Jan. 9, 2026, the entire disclosures of which are incorporated herein by reference for all purposes.

### FIELD OF THE INVENTION

The present invention relates to a connector and, more particularly, to a high-power connector.

### BACKGROUND OF THE INVENTION

Various electrical connectors are used in the electrical field. In addition, in some cases, connectors are used to connect a high-voltage range and/or a high-current range. Hereinafter, a connector that connects high voltage and/or high current is referred to as a high-power connector, and the term “high-power” is intended to include “high-voltage.” For example, a battery for a wireless vacuum cleaner uses a high-power connector. The high-power connector is used to apply current.

Meanwhile, a high-power connector requires a large number of contacts to apply high current, and the size of the connector increases in proportion to the number of contacts. In addition, when high current is applied, the high-power connector exhibits a great temperature rise. To suppress the temperature rise, the size of the connector needs to be increased. Therefore, to increase the current capacity of a battery, the size of the battery increases in proportion thereto, and the weight thereof also increases.

Accordingly, there is a need to develop a high-power connector for maximizing current capacity while minimizing the weight of a battery.

The above description has been possessed or acquired by the inventor(s) in the course of conceiving the present disclosure and is not necessarily an art publicly known before the present application is filed.

### SUMMARY OF THE INVENTION

A high-power connector includes a receptacle assembly and a tab assembly. The receptacle assembly includes a plurality of receptacle-side power terminals for forming multiple contacts, and a plurality of receptacle-side signal terminals. The plurality of receptacle-side power terminals are disposed in parallel. The tab assembly includes a plurality of tab-side power terminals corresponding to the plurality of receptacle-side power terminals, and a plurality of tab-side signal terminals corresponding to the plurality of receptacle-side signal terminals.

### BRIEF DESCRIPTION OF DRAWINGS

The invention will now be described by way of example with reference to the accompanying figures, of which:

FIG. 1 is a perspective view of a high-power connector according to an embodiment;

FIG. 2 is a plan view of the high-power connector of FIG. 1;

FIG. 3 is a plan view illustrating a state in which a receptacle assembly and a tab assembly are coupled to each other in the high-power connector of FIG. 1;

FIG. 4 is a perspective view of a receptacle-side power terminal according to an embodiment; and

FIG. 5 is an exploded perspective view of the receptacle-side power terminal of FIG. 4 and a tab-side power terminal according to an embodiment.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. It should be noted that if one component is described as being “connected,” “coupled,” or “joined” to another component, the former may be directly “connected,” “coupled,” or “joined” to the latter directly or via another component.

A component, which has the same common function as a component included in any one embodiment, will be described by using the same name in other embodiments. Unless disclosed to the contrary, the description of any one embodiment may be applied to other embodiments, and the specific description of the repeated configuration will be omitted.

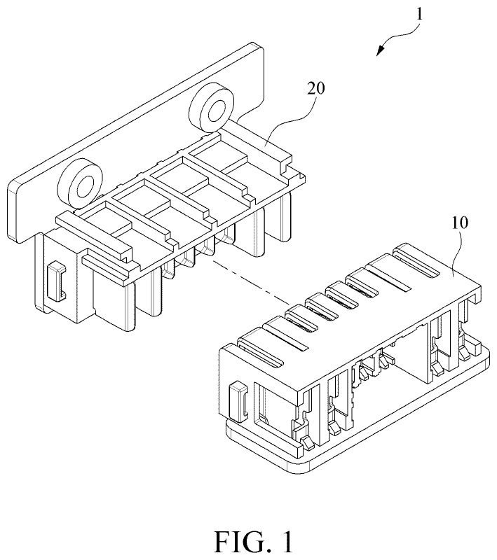

An exemplary embodiment of a high-power connector 1 will be described with reference to FIGS. 1-5. As shown in FIGS. 1-3, the high-power connector 1 includes a receptacle assembly 10 and a tab assembly 20.

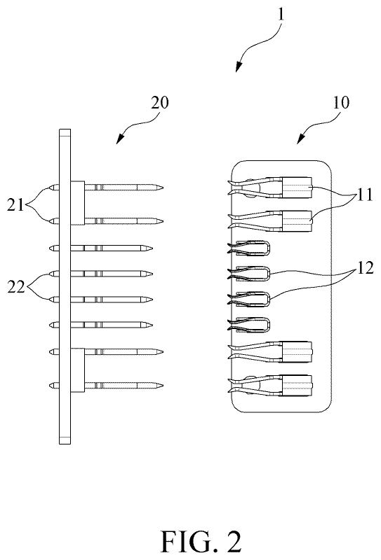

As shown in FIG. 2, the receptacle assembly 10 includes a plurality of receptacle-side power terminals 11 having a multi-contact structure for applying high current, and a plurality of receptacle-side signal terminals 12 for transmitting signals.

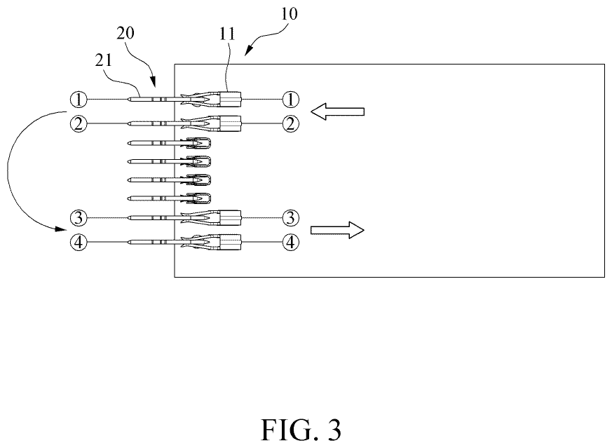

The receptacle assembly 10, as shown in FIGS. 2-3, includes a plurality of receptacle-side power terminals 11 disposed in parallel. The receptacle-side power terminals 11 are grouped in pairs such that current is applied simultaneously to each pair. For example, the receptacle assembly 10 includes at least two pairs of receptacle-side power terminals 11. In addition, the receptacle assembly 10 includes two pairs of receptacle-side power terminals 11 disposed in parallel, current is applied through one pair of receptacle-side power terminals 11, and the current flows to the other pair of receptacle-side power terminals 11 through a tab-side power terminal 21. Further, when a current of 30 amperes (A) is applied to each pair of receptacle-side power terminals 11, a high current of 60 A may be applied to the high-power connector 1 as a whole. When a current of 30 A is applied to the receptacle-side power terminals 11 and a temperature rise of 25° C. occurs, a temperature rise of 25° C. occurs in the high-power connector 1 as a whole since the receptacle-side power terminals 11 are connected in parallel as described above. As a result, by suppressing a temperature rise of the high-power connector 1, the temperature of a battery may be maintained at a constant level, thereby enabling the battery to provide maximum performance. However, the number and arrangement of receptacle-side power terminals 11 are not limited by the drawings and may be variously modified in practice.

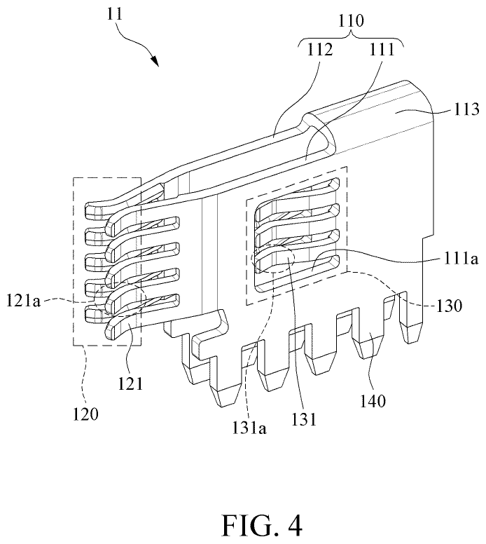

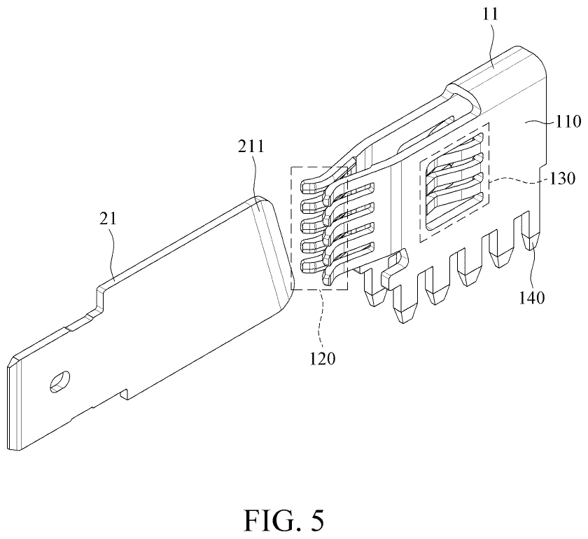

Here, the receptacle-side power terminals 11 are formed to have multiple contacts to apply high current within a limited size, and may form as many contacts as possible within a limited size. As shown in FIGS. 4-5, the receptacle-side power terminal 11 includes a body portion 110, a plurality of contact rows 120 and 130, and a soldering tail 140.

The body portion 110, as shown in FIG. 4, includes a pair of a first body plate 111 and a second body plate 112 having shapes corresponding to each other. The first body plate 111 and the second body plate 112 are provided parallel to each other while being spaced apart from each other by a predetermined distance so as to form a space for fitting with the tab-side power terminal 21, which is a coupling target, therein.

As shown in FIG. 4, the first body plate 111 and the second body plate 112 are connected to each other at a connection portion 113 formed on one side of an edge of the body portion 110. That is, the first and second body plates 111 and 112 may be molded as a single member, and may be bent at the connection portion 113 to form the body portion 110. However, the connection portion 113 is merely an example for ease of description, and the position, size, and shape of the connection portion 113 are not limited by the drawings.

As shown in FIG. 4, in each of the first body plate 111 and the second body plate 112, two contact rows 120 and 130 are formed by arranging a plurality of contact beams 121 and 131. Here, the first body plate 111 and the second body plate 112 have substantially the same shape, and thus, the first body plate 111 will be described hereinafter.

The contact rows 120 and 130, as shown in FIG. 4, include rows of contact beams 121 and 131 formed by arranging the plurality of contact beams 121 and 131 side by side. The first contact row 120 is formed as the plurality of first contact beams 121 and extend outward from one edge of the first body plate 111. The second contact row 130 is formed as a predetermined opening 111a, is formed in a surface of the first body plate 111, and the plurality of second contact beams 131 extend from one edge of the opening 111a in the same direction as the first contact beams 121. Here, the first contact row 120 and the second contact row 130 are sequentially formed along a direction in which the tab-side power terminal 21, which will be described later, is inserted into the receptacle-side power terminal 11. That is, the receptacle-side power terminal 11 is formed to sequentially contact the first contact row 120 and the second contact row 130 when the tab-side power terminal 21 is inserted.

As shown in FIG. 4, each of the first contact beams 121 and the second contact beams 131 are formed as a cantilever beam having one end fixed to the first body plate 111 and the other end as a free end. In addition, the first contact beams 121 and the second contact beams 131 are bent to be curved toward an inner space of the receptacle-side power terminal 11 to form contact points 121a and 131a. That is, the first contact beams 121 and the second contact beams 131 electrically contact the tab-side power terminal 21 at the contact points 121a and 131a when the tab-side power terminal 21 is inserted. Further, since the first contact beams 121 and the second contact beams 131 have a cantilever beam shape, the first contact beams 121 and the second contact beams 131 elastically contact the tab-side power terminal 21 by their own elasticity, thereby stably maintaining a contact state.

In addition, the first contact beams 121 and the second contact beams 131 have substantially the same shape and size. Further, a spacing between the first contact beams 121 and a spacing between the second contact beams 131 may be substantially equal to each other.

The first contact row 120 and the second contact row 130 simultaneously electrically contact the tab-side power terminal 21 to form multiple contacts. For example, five first contact beams 121 are disposed in the first contact row 120, and three second contact beams 131 are disposed in the second contact row 130, such that eight contacts with the tab-side power terminal 21 are formed. In addition, as described above, eight contacts are formed identically on each of the first and second body plates 111 and 112, such that the receptacle-side power terminal 11 forms a total of sixteen contacts with the tab-side power terminal 21.

As shown in FIG. 4, according to the present embodiment, the first contact beams 121 and the second contact beams 131 include contact points 121a and 131a formed in a rounded curved shape, thereby reducing the insertion force when the tab-side power terminal 21 is inserted. Here, in general, the insertion force increases in proportion to the number of contacts. However, in the receptacle-side power terminal 11 according to the present embodiment, the tab-side power terminal 21 is inserted while sliding along the curved surfaces of the contact points 121a and 131a when the tab-side power terminal 21 is assembled, and thus, it is possible to prevent a rapid increase in the insertion force and reduce the insertion force. In addition, since the tab-side power terminal 21 sequentially comes into contact with the first contact row 120 and the second contact row 130, the receptacle-side power terminal 11 may prevent a rapid increase in the insertion force. Further, since the first contact row 120 and the second contact row 130 are formed, a large number of contacts may be formed without increasing the size of a single receptacle-side power terminal 11.

As shown in FIGS. 4-5, the soldering tail 140 is formed at one edge of the first body plate 111, and is formed to be divided into a plurality of portions. In addition, the soldering tail 140 is formed at an edge on which the first contact row 120 is not formed. By forming a plurality of soldering tails 140, the receptacle-side power terminal 11 may increase the cross-sectional area of portions soldered to a printed circuit board (PCB), thereby applying high current and simultaneously suppressing a temperature increase occurring when high current is applied.

The receptacle-side signal terminals 12 are disposed between receptacle-side power terminals 11, and are not terminals for high-current application and thus do not need to be multi-contact terminals. In addition, receptacle terminals of a general type may be used as the receptacle-side signal terminals 12. Likewise, terminals of a general type may be used as tab-side signal terminals 22.

As shown in FIG. 2, the tab assembly 20 includes a plurality of tab-side power terminals 21 and a plurality of tab-side signal terminals 22 so as to correspond to the receptacle assembly 10. That is, the tab assembly 20 is formed so that the plurality of tab-side power terminals 21 correspond one-to-one with the plurality of receptacle-side power terminals 11 and the plurality of tab-side signal terminals 22 correspond one-to-one with the plurality of receptacle-side signal terminals 12.

As shown in FIG. 5, the tab-side power terminal 21 has a leading end portion 211, to be coupled with a receptacle-side power terminal 11, formed to have an inclined surface. The leading end portion 211 of the tab-side power terminal 21 is formed such that an upper portion, which is a portion that contacts the contact rows 120 and 130 of the receptacle-side power terminal 11, has a wider inclined surface than a lower portion. Accordingly, the tab-side power terminal 21 sequentially comes into contact with the contact rows 120 and 130 of the receptacle-side power terminal 11 when coupled to the receptacle-side power terminal 11, thereby reducing the insertion force.

According to the aforementioned embodiments, the high-power connector 1 includes the plurality of receptacle-side power terminals 11 having a multi-contact structure, thereby applying high current while minimizing the size and weight of the high-power connector 1.

While the embodiments have been described with reference to the drawings, it will be apparent to one of ordinary skill in the art that various alterations and modifications can be made from the above description. For example, suitable results may be achieved if the described techniques are performed in a different order, and/or if components in a described system, structure, device, or circuit are combined in a different manner, and/or replaced or supplemented by other components or their equivalents. Therefore, other implementations, other embodiments, and equivalents to the claims are also within the scope of the following claims.

1. A high-power connector comprising:
a receptacle assembly including a plurality of receptacle-side power terminals for forming multiple contacts, and a plurality of receptacle-side signal terminals, the plurality of receptacle-side power terminals are disposed in parallel; and
a tab assembly including a plurality of tab-side power terminals corresponding to the plurality of receptacle-side power terminals, and a plurality of tab-side signal terminals corresponding to the plurality of receptacle-side signal terminals.

2. The high-power connector of claim 1, wherein the receptacle assembly groups the plurality of receptacle-side power terminals in pairs and applies current thereto.

3. The high-power connector of claim 2, wherein the receptacle assembly includes at least two pairs of receptacle-side power terminals.

4. The high-power connector of claim 1, wherein the plurality of receptacle-side power terminals are provided in at least two pairs.

5. The high-power connector of claim 1, wherein each of the receptacle-side power terminals includes a body portion, a first contact row, a second contact row, and a soldering tail.

6. The high-power connector of claim 5, wherein the body portion includes a pair of a first body plate and a second body plate having shapes corresponding to each other.

7. The high-power connector of claim 6, wherein the first contact row is formed at one edge of each of the first body plate and the second body plate.

8. The high-power connector of claim 7, wherein the first contact row has a plurality of first contact beams arranged side by side.

9. The high-power connector of claim 8, wherein the second contact row is formed in a surface of each of the first body plate and the second body plate, the second contact row has a plurality of second contact beams arranged side by side.

10. The high-power connector of claim 7, wherein the soldering tail is formed on an other edge of each of the first body plate and the second body plate, the soldering tail is soldered to a printed circuit board.

11. The high-power connector of claim 9, wherein the first contact row and the second contact row are formed to sequentially contact a corresponding tab-side power terminal with respect to a direction in which the corresponding tab-side power terminal is assembled.

12. The high-power connector of claim 9, wherein the first contact beams and the second contact beams each have a same size and a same shape.

13. The high-power connector of claim 12, wherein the second contact row is formed at one edge of an opening formed in a surface of each of the first body plate and the second body plate, and includes the second contact beams arranged in a same direction as the first contact beams.

14. The high-power connector of claim 13, wherein a spacing between the first contact beams and a spacing between the second contact beams are equal to each other.

15. The high-power connector of claim 13, wherein the second contact row includes a number of second contact beams smaller than a number of first contact beams.

16. The high-power connector of claim 14, wherein the first contact beams and the second contact beams are curved toward an inner space of the body portion to form contact rows to be electrically connected to a corresponding tab-side power terminal.

17. The high-power connector of claim 10, wherein the soldering tail is formed to be divided into a plurality of portions.

18. The high-power connector of claim 17, wherein the soldering tail is formed at an edge on which the first contact row is not formed.

19. The high-power connector of claim 9, wherein each of the tab-side power terminals includes a leading end portion that has an upper portion and a lower portion, each upper portion contacts the first contact row and the second contact row of a corresponding one of the receptacle-side power terminals, each upper portion is formed as a wider inclined surface than one lower portion.
